(19) United States
(12) Patent Application Publication
(10) Pub. No.: US 2026/0175320 A1
(43) Pub. Date: Jun. 25, 2026

(54) LASER PROCESSING MONITORING DEVICE

(71) Applicant: Panasonic Intellectual Property Management Co., Ltd., Osaka (JP)

(72) Inventors: AKIRA KUMAGAWA, Osaka (JP); YOSHIRO KITAMURA, Osaka (JP); IZURU NAKAI, Osaka (JP)

(21) Appl. No.: 19/534,560

(22) Filed: Feb. 9, 2026

Related U.S. Application Data
(63) Continuation of application No. PCT/JP2024/036166, filed on Oct. 9, 2024.

(30) Foreign Application Priority Data
Dec. 12, 2023 (JP) 2023-209368

(51) Int. Cl. B23K 26/03; B23K 26/04; B23K 26/062; B23K 26/082

(52) U.S. Cl. CPC B23K 26/032; B23K 26/04; B23K 26/0626; B23K 26/082

(57) ABSTRACT

A laser processing monitoring device includes at least two optical sensors (16, 17, 23) that detect emitted light generated from a workpiece subjected to laser processing, and light attenuating elements (13, 21) disposed on at least one optical path among at least two optical paths branched off from the emitted light to be transmitted to the at least two optical sensors, wherein the light attenuating element has a transmittance to cause measurement ranges of the at least two optical sensors to be continuous.

### TECHNICAL FIELD

The present disclosure relates to a laser processing monitoring device capable of monitoring laser processing.

### BACKGROUND ART

The laser welding technique is a technique of emitting a laser beam from a laser oscillator to a workpiece to melt the workpiece with heat of the laser beam, and thereby welding the workpiece to another workpiece to mechanically and/or electrically connect these workpieces. In general, laser welding techniques are widely used in a wide variety of fields, such as consumer electronics, precision equipment, and automotive parts.

In these laser welding techniques, generally, various adjustment items are adjusted according to a laser oscillator or the shape or size of a workpiece through trial and error. Cases where a processed workpiece cannot meet a predetermined quality may include a case where adjustment cannot be made through such trial and error.

PTL 1 discloses that a laser processing state can be monitored in real time by detecting welding light at a processing point.

### Citation List

### Patent Literature

PTL 1: Unexamined Japanese Patent Publication No. 2021-186848

### SUMMARY OF THE INVENTION

As illustrated in FIG. 7, the laser processing device according to Patent Literature 1 includes optical sensors 100 to 102, and observes welding light LW100 generated from workpiece W100 for each wavelength.

In each sensor, when the light emission intensity at the observed processing point is large, the light amount cannot be adjusted, so that an output signal of the optical sensor saturates and the state of the processing point cannot be detected. In addition, in a case where an optical element is added to an optical system to attenuate the light, when a shift of an optical axis occurs due to the configurational change of the optical system, accurate measurement is difficult.

An object of the present disclosure is to provide a laser processing monitoring device that can monitor laser processing in a wide dynamic range with no change in the configuration of an optical system.

A laser processing monitoring device according to one aspect of the present disclosure includes

at least two optical sensors that detect emitted light generated from a workpiece subjected to laser processing, and

a light attenuating element disposed on at least one optical path among at least two optical paths branched off from the emitted light to be transmitted to the at least two optical sensors, wherein

the light attenuating element has a transmittance to cause measurement ranges of the at least two optical sensors to be continuous.

The laser processing monitoring device includes an optical system in which the light amount transmittances to at least two optical sensors are all different.

The transmittance of a light attenuating element is set such that the measurement ranges of at least two optical sensors are continuous. At least two optical sensors can be used as a single optical sensor having a continuous measurement range. Such a laser processing monitoring device has a wider measurement range than a laser processing monitoring device including a single optical sensor.

### BRIEF DESCRIPTION OF THE DRAWINGS

FIG. 1 is a schematic diagram illustrating a configuration of a laser processing monitoring device according to a first exemplary embodiment of the present disclosure.

FIG. 2A is a view of a portion extracted from FIG. 1 to include from partial reflection mirror 11 to optical sensors 16, 17.

FIG. 2B is a schematic diagram illustrating the transmittance of a light attenuating element in the first exemplary embodiment of the present disclosure in a chart where the horizontal axis is adjustment step, and the vertical axis is light intensity (W).

FIG. 3A is a measurement flowchart according to the first exemplary embodiment of the present disclosure.

FIG. 3B is a measurement flowchart according to the first exemplary embodiment of the present disclosure.

FIG. 3C is a measurement flowchart according to the first exemplary embodiment of the present disclosure.

FIG. 4A is a schematic diagram of gain adjustment according to the light intensity of welding light LW in a gain adjustor in the measurement flow.

FIG. 4B is a schematic diagram of gain adjustment according to the light intensity of welding light LW in the gain adjustor in the measurement flow.

FIG. 4C is a schematic diagram of gain adjustment according to the light intensity of welding light LW in the gain adjustor in the measurement flow.

FIG. 4D is a schematic diagram of gain adjustment according to the light intensity of welding light LW in the gain adjustor in the measurement flow.

FIG. 5A is a schematic diagram illustrating a configuration of a measurement unit according to a second exemplary embodiment of the present disclosure.

FIG. 5B is a schematic diagram illustrating the transmittance of a light attenuating element in the second exemplary embodiment of the present disclosure in a chart where the horizontal axis is adjustment step, and the vertical axis is light intensity (W).

FIG. 6 is a measurement flowchart of a case where the number of optical sensors is n according to the second exemplary embodiment of the present disclosure.

FIG. 7 is a schematic diagram of a laser processing device in a conventional example.

### DESCRIPTION OF EMBODIMENT

Exemplary embodiments of the present disclosure will be described below with reference to the drawings.

### First exemplary embodiment

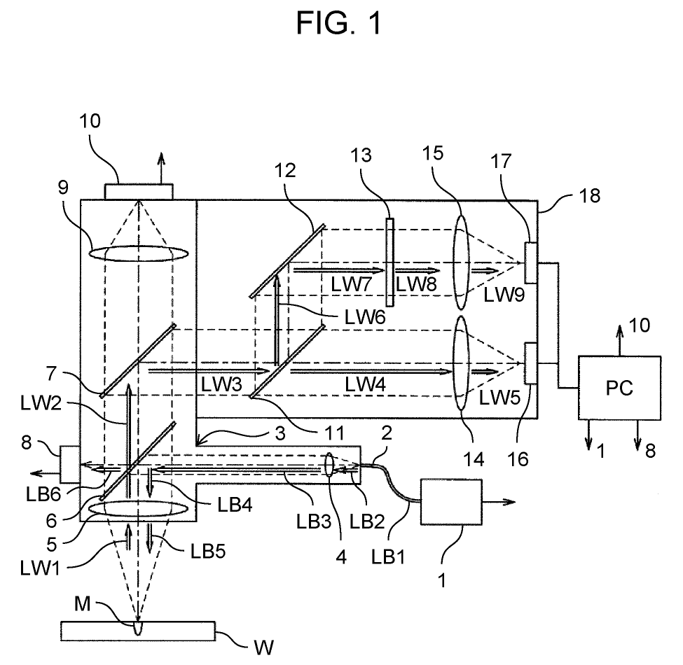

FIG. 1 is a schematic diagram illustrating a configuration of a laser processing monitoring device according to a first exemplary embodiment of the present disclosure. Laser processing is a method of performing welding, cutting, drilling, marking, surface treatment, etching, deposition, or the like using a laser beam. Here, laser welding is exemplified, but the present disclosure is not limited thereto.

The laser processing monitoring device includes a laser beam supply unit and a light detection unit.

The laser beam supply unit includes laser oscillator 1, optical fiber 2 for laser beam transmission, collimating lens 4, partial reflection mirror 6, and condensing lens 5.

The light detection unit further includes laser output sensor 8, partial reflection mirror 7, condensing lens 9, imaging camera 10, partial reflection mirror 11, reflection mirror 12, light attenuating element 13, condensing lenses 14, 15, and optical sensors 16, 17. Many of these components can be housed inside lens barrel 3.

The laser processing monitoring device further includes a calculation unit PC as an example controller that controls the entire device.

Laser oscillator 1 is implemented as, for example, a gas laser such as carbon dioxide laser or a solid laser such as YAG laser, semiconductor laser, and fiber laser, and generates a laser beam having a predetermined wavelength and a predetermined output. As an example, the laser beam is a continuous wave (CW) having a wavelength of 1070 nm. An optimum laser wavelength can be selected according to the light absorption characteristics of workpiece W. For example, when workpiece W is copper Cu or gold Au, the laser wavelength is preferably a relatively short wavelength that ranges from 405 nm to 450 nm, for example. When workpiece W is made of aluminum, the laser wavelength is preferably about 800 nm because aluminum has preferable light absorption characteristics to enable preferable welding.

Here, a case where a continuous wave is used as a laser beam is exemplified, but a pulse wave laser beam may be used. Using a continuous wave laser beam can increase the amount of heat input to workpiece W, and thus is preferable in terms of high productivity. Using a pulse wave laser beam is preferable in that a thermal effect during processing can be reduced as compared with a case using a continuous wave.

Laser oscillator 1 is communicably connected to calculation unit PC to enable controlling of the output of the laser beam in response to a command from calculation unit PC, and in the case of a pulse wave, the period and the duty cycle can also be controlled.

Optical fiber 2 for laser beam transmission has a function of transmitting light beam LB1 from laser oscillator 1 to the inside of lens barrel 3. Instead of using optical fiber 2, a laser beam emitted from laser oscillator 1 can be guided to lens barrel 3 using an optical element such as a mirror.

Collimating lens 4 is disposed in lens barrel 3 and converts light beam LB2 emitted from optical fiber 2 into parallel light beam LB3.

Partial reflection mirror 6 is disposed in lens barrel 3, and has a function of reflecting most of light beam LB3 from collimating lens 4 and transmitting a portion of light beam LB3. In the first exemplary embodiment, partial reflection mirror 6 is, for example, a mirror that uses a dichroic mirror to reflect 90% or more of the light in a wavelength range of the laser beam generated by laser oscillator 1 and transmit 50% or more of the light in a wavelength range from 350 nm to 2000 nm, that is, out of the wavelength range of the laser beam. For partial reflection mirror 6, desired optical characteristics can be selected according to a wavelength to be reflected or a wavelength to pass through, and the ratio between the transmitted light amount and the reflected light amount may be changed as necessary. Light beam LB6 that has passed through partial reflection mirror 6 is received by laser output sensor 8 that is disposed on a wall of lens barrel 3 and monitors the output of the laser beam, the wall being on the side opposite to the side where light beam LB6 enters partial reflection mirror 6.

Laser output sensor 8 includes a photodiode, an A/D converter, and the like, and is communicably connected to calculation unit PC. A detection signal of laser output sensor 8 is input to calculation unit PC. The detection signal of laser output sensor 8 correlates with the laser output of laser oscillator 1. When the laser output is high, an optical element that attenuates light may be provided in front of laser output sensor 8. To reduce surface reflection at the sensor or the optical element, the light receiving surface of laser output sensor 8 may be disposed with an angle with respect to the traveling direction of light beam LB6.

Condensing lens 5 is disposed in lens barrel 3 and condenses light beam LB4 reflected by partial reflection mirror 6 to form a light spot having a predetermined shape on a surface of workpiece W. A large amount of heat energy is input to a region irradiated with the light spot, and a portion of which temperature has exceeded a melting point becomes molten region M where welding of workpiece W, for example, is performed.

Workpiece W is supported on a processing stage (not illustrated) including an XYZθ table, for example. Such a processing stage is communicably connected to calculation unit PC, and the three-dimensional position of workpiece W and the angle about the optical axis of light beam LB5 can be controlled in response to a command from calculation unit PC.

Methods that can be employed to scan workpiece W with light beam LB5 include 1) a method of moving the processing stage in a predetermined direction at a predetermined speed with lens barrel 3 and light beam LB5 fixed, 2) a method of moving lens barrel 3 mounted on a scanning mechanism such as a robot arm or a linear stage in a predetermined direction at a predetermined speed with the processing stage fixed, 3) a method of installing an optical scanner such as a galvanometer mirror between condensing lens 5 and workpiece W, and 4) a combination of the methods 1) to 3). Irradiation and scanning of workpiece W with light beam LB5 may be performed separately, but a continuous welded portion can be formed by performing irradiation and scanning simultaneously.

Calculation unit PC is configured with a computer including a processor, a memory, a mass storage, and the like, and executes various operations instructed by preset programs. Calculation unit PC also performs storing of gains of optical sensors 16, 17, control of setting and adjustment of the gains, and management of a gain adjustment completion flag.

In the first exemplary embodiment, the laser processing monitoring device detects welding light LW1 as an example of emitted light generated from molten region M during irradiation with the laser beam. At least two optical sensors 16, 17 extend the dynamic range of the laser processing monitoring device.

A portion of welding light LW1 generated from molten region M enters condensing lens 5, passes through partial reflection mirror 6 in the optical axis direction of condensing lens 5, and enters partial reflection mirror 7. Partial reflection mirror 7 has a function of reflecting and transmitting incident light at a predetermined ratio. In the first exemplary embodiment, as an example, a half mirror that is disposed in lens barrel 3 and transmits about 50% and reflects about 50% of light having a wavelength that ranges from 350 nm to 2000 nm is used as partial reflection mirror 7. Note that the ratio between the transmitted light amount and the reflected light amount may be changed according to the wavelength by using a dichroic mirror having wavelength dependency as partial reflection mirror 7.

The light that has passed through partial reflection mirror 7 passes through condensing lens 9 disposed in lens barrel 3 and is received by imaging camera 10. Imaging camera 10 has a function of detecting the light generated from molten region M during irradiation with the laser beam and imaging molten region M and its peripheral region. Imaging camera10 includes an image sensor and an A/D converter, and is communicably connected to calculation unit PC. Imaging camera 10 outputs a detection signal. The detection signal is input to calculation unit PC. The sampling period (measurement period) of imaging camera 10 is desirably 1/100 or less of the time for performing output control of laser irradiation to obtain a clear image, because when the sampling period is slow, the light averaged within the sampling period forms a blurred image.

The light reflected by partial reflection mirror 7 is incident on partial reflection mirror 11. As an example, in the first exemplary embodiment, partial reflection mirror 11 is configured with a half mirror, and reflects light of about 50% of the amount of welding light LW1 generated from molten region M and transmits the rest of about 50% of the light. Welding light LW4 that has passed through partial reflection mirror 11 is condensed by condensing lens 14 and received by optical sensor 16, and forms an optical path.

Welding light LW6 reflected by partial reflection mirror 11 is incident on reflection mirror 12, and forms another optical path. Welding light LW7 reflected by reflection mirror 12 passes through light attenuating element 13. Light attenuating element 13 includes, for example, Neutral Density filter (hereinafter ND filter). As another example, light attenuating element 13 may be configured with, instead of the ND filter, a half mirror, a dichroic mirror, or any combination of these three.

The light that has passed through light attenuating element 13 is condensed by condensing lens 15 and received by optical sensor 17.

Optical sensors 16, 17 detect the intensities of the received lights and convert the intensities into electrical signals such as voltage values or current values. Optical sensors 16, 17 each include a photodiode and an A/D converter, and are communicably connected to calculation unit PC. Detection signals of optical sensors 16, 17 are input to calculation unit PC. The light received by optical sensor 17 is attenuated by light attenuating element 13. When gain settings of optical sensors 16, 17 are the same, the measurement range of optical sensor 17 is larger than the measurement range of optical sensor 16. Calculation unit PC serves as a gain controller for optical sensors 16, 17.

In the first exemplary embodiment, the measurement ranges of light intensities that can be measured by optical sensors 16, 17 are the same, and when the measurement ranges are from A W to B W (A and B are constants), an ND filter having a transmittance α₁ (A/B < α₁ < 1.0) is used as light attenuating element 13. Note that a beam splitter having a desired reflectance may be used instead of reflection mirror 12 as light attenuating element 13.

The measurement regions of optical sensors 16, 17 are preferably set to include molten region M of workpiece W. When changing the measurement region, for example, a method of adjusting the focal lengths of condensing lenses 14, 15 may be used. For example, when a lens having a focal length of 100 mm is used as condensing lenses 14, 15 instead of a lens having a focal length of 200 mm, a region that is twice the light receiving size of optical sensors 16, 17 can be measured. It is preferable to adjust the focal length according to the measurement region selected by such a way. As another example, a method of limiting the measurement region by providing an aperture with a changeable opening diameter immediately before optical sensors 16, 17 can also be used.

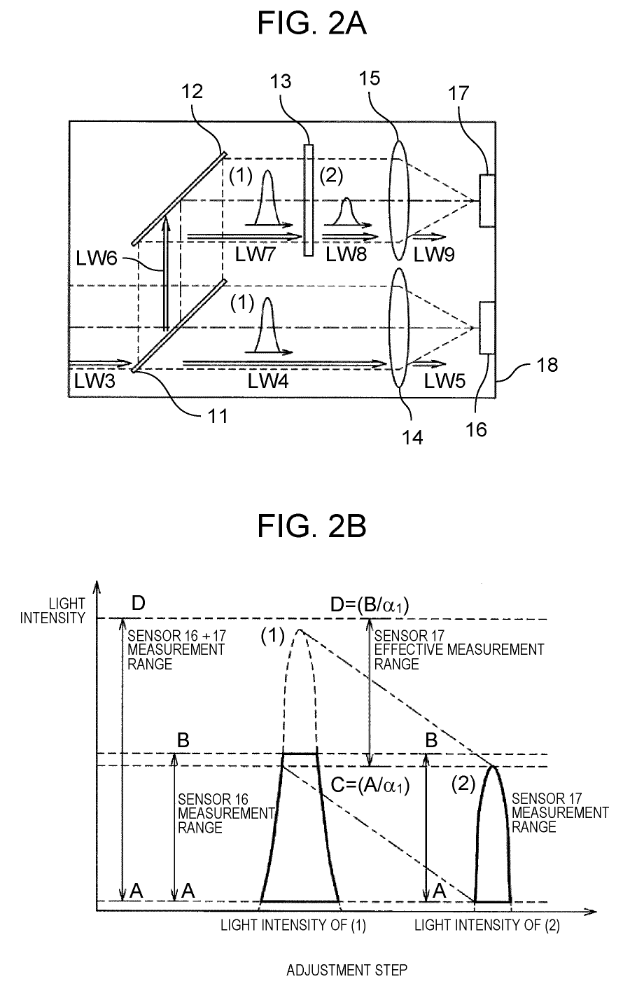

FIG. 2A illustrates a diagram of a portion extracted from FIG. 1 to include from partial reflection mirror 11 to optical sensors 16, 17 (referred to as measurement unit 18), and FIG. 2B illustrates a transmittance of light attenuating element 13 using a chart in which the horizontal axis is adjustment step and the vertical axis is light intensity (W). In the first exemplary embodiment, the transmittance of light attenuating element 13 is set such that the measurement ranges of optical sensor 16 and optical sensor 17 are continuous. The transmittance of light attenuating element 13 is α₁ (< 1.0). The measurement ranges of optical sensors 16, 17 are from A W to B W. The light intensities of welding light LW4 and welding light LW7 are the same, and are indicated by (1) in FIG. 2A and FIG. 2B. For the light intensity of (1), the low intensity portion is measured by optical sensor 16, and the high intensity portion is measured by optical sensor 17. As the light is attenuated by light attenuating element 13, optical sensor 17 measures attenuated welding light LW8, that is, the light intensity of (2) in FIG. 2A and FIG. 2B. At this time, when the effective measurement range of the light intensity at optical sensor 17 for the light intensity of (1) ranges from C W to D W (C and D are constants), the transmittance α₁ and the measurement ranges from A W to B W of LW7 are used to express C = A/α₁ and D = B/α₁. To make the measurement ranges of optical sensor 16 and optical sensor 17 continuous, lower limit C = A/α₁ of the measurement range of the light intensity at optical sensor 17 needs to be smaller than upper limit B of the measurement range of the light intensity at optical sensor 16, so that the measurement range of optical sensor 17 becomes continuous with the measurement range of optical sensor 16 by setting transmittance α₁ of light attenuating element 13 to satisfy α₁ > A/B. With this configuration, transmittances are set for the two optical paths branched from an emitted light such as a welding light transmitted to two optical sensors 16, 17 such that the measurement ranges of two optical sensors 16, 17 are continuous.

Note that, as described above, light attenuating element 13 is disposed in one of the two branched optical paths to configure an optical system in which the light amount transmittances to optical sensors 16, 17 are all different.

Next, a light detection method of the first exemplary embodiment of the present disclosure will be described.

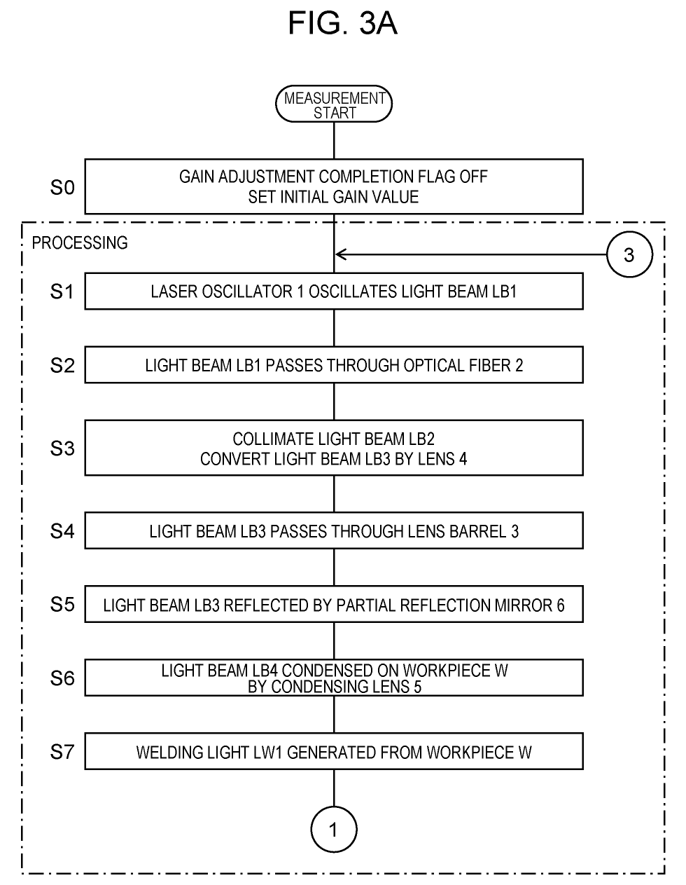

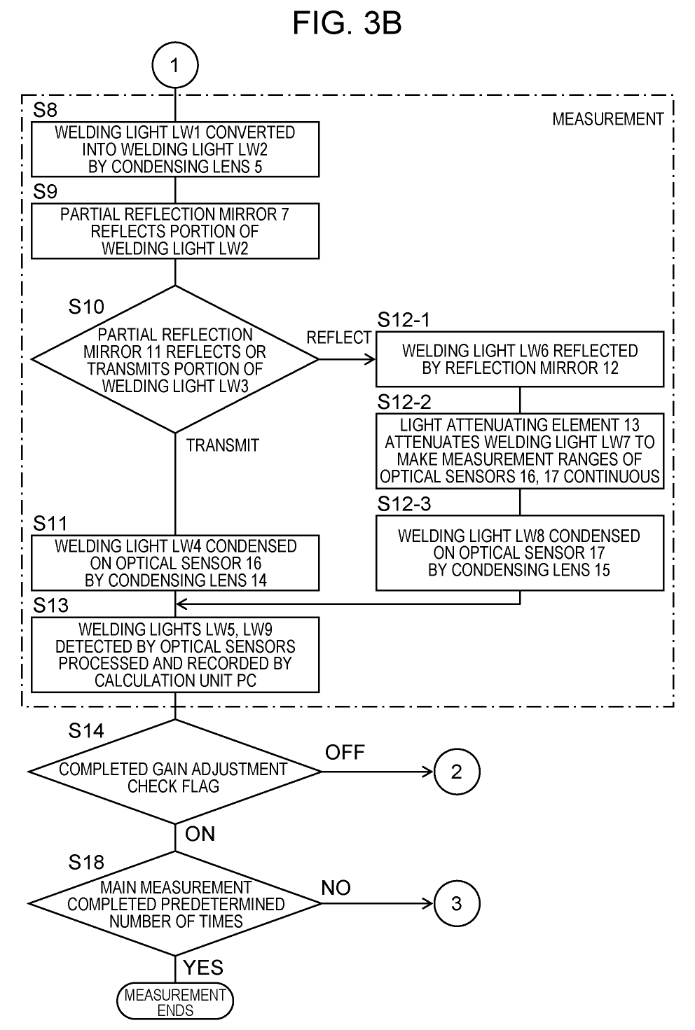

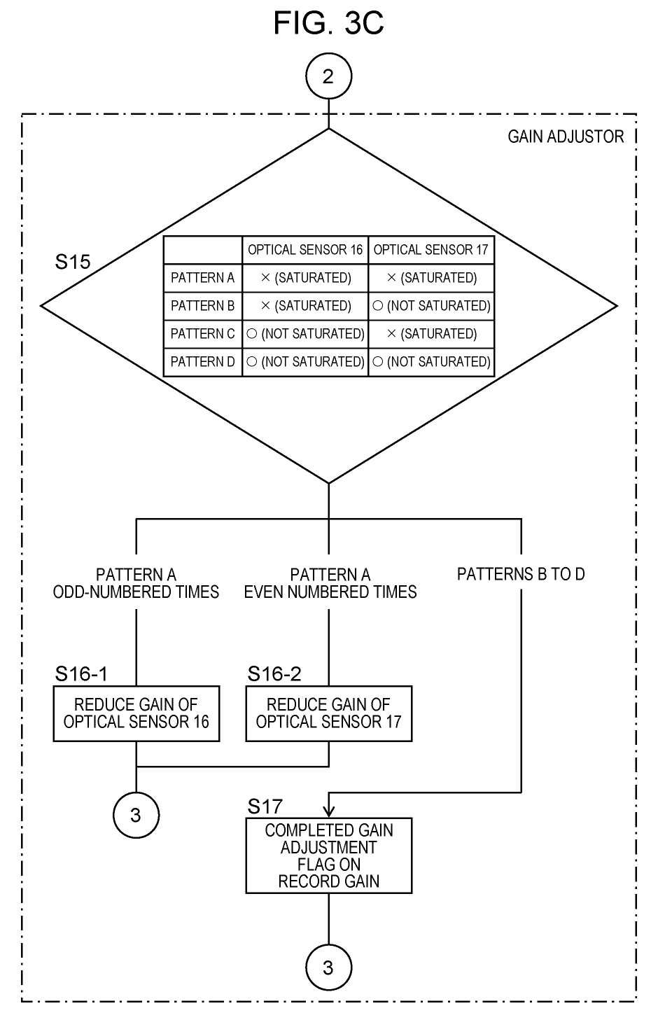

FIG. 3A, FIG. 3B, and FIG. 3C are measurement flowcharts under the control of calculation unit PC of the first exemplary embodiment of the present disclosure.

First, the gain adjustment completion flag is turned off, and an initial gain value is set by calculation unit PC (step S0).

Next, under the control of calculation unit PC, laser oscillator 1 oscillates light beam LB1 (step S1), and light beam LB1 passes through optical fiber 2 (step S2).

Next, light beam LB2 becomes light beam LB3 by collimating lens 4 (step S3), and light beam LB3 passes through lens barrel 3 (step S4).

Next, light beam LB3 is reflected by partial reflection mirror 6 to become light beam LB4 (step S5), light beam LB4 is condensed by condensing lens 5 to become light beam LB5, and workpiece W is irradiated with light beam LB5 (step S6), whereby welding light LW1 is generated from workpiece W (step S7).

Next, generated welding light LW1 becomes welding light LW2 by condensing lens 5 (step S8), and a portion of welding light LW2 is reflected by partial reflection mirror 7 to become LW3 (step S9).

Next, a portion of welding light LW3 reflected by partial reflection mirror 7 passes through partial reflection mirror 11 to become welding light LW4, and the rest is reflected by partial reflection mirror 11 to become welding light LW6 (step S10). Welding light LW4 passes through condensing lens 14 to become LW5, and is condensed on optical sensor 16 (step S11). Welding light LW6 is reflected by reflection mirror 12 to become welding light LW7 (step S12-1), and welding light LW7 passes through light attenuating element 13 to be attenuated into welding light LW8 (step S12-2). Welding light LW8 passes through condensing lens 15 to become LW9, and is condensed on optical sensor 17 (step S12-3).

Next, the intensity data of welding lights LW5, LW9 detected by optical sensors 16, 17 are processed by calculation unit PC and recorded (step S13).

When optical sensors 16, 17 detect the welding lights, it is necessary to set gains and adjust signal intensities by calculation unit PC, but there is a case where an initial value is set at the time of measurement but is not valid. Calculation unit PC checks the gain adjustment completion flag, and when the gain adjustment is not completed, gain adjustment is performed and then the step proceeds to gain recording (step S14).

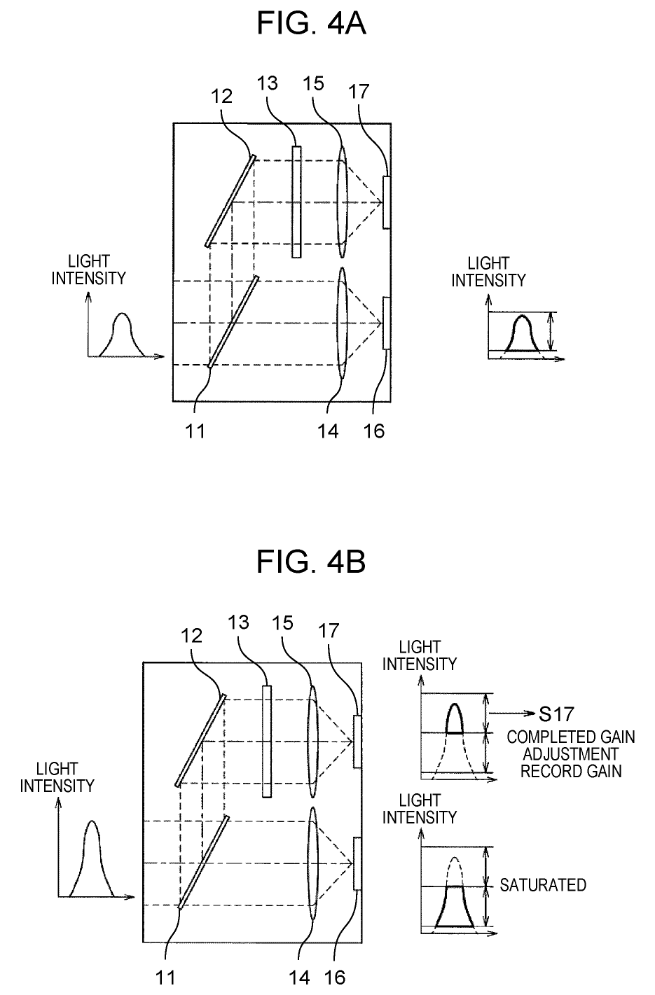

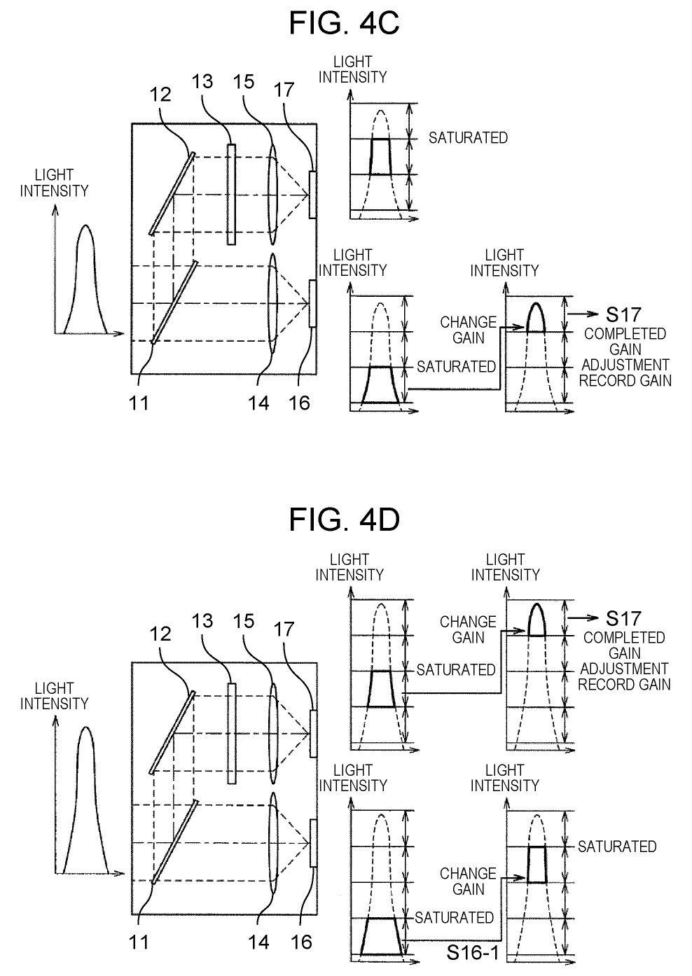

FIG. 4 is a schematic diagram of gain adjustment according to the light intensity of welding light LW by a gain adjustor in the measurement flow (steps S15 to S17). Welding lights LW1 to LW9 may be collectively referred to as welding light LW.

For the gain adjustment by calculation unit PC, the adjustment is performed under a laser beam condition where the signal intensity is assumed to be the highest among laser beam conditions that may be used. A suitable condition is generally a condition with the maximum laser power or the maximum energy density, but if it is difficult to uniquely determine the condition, the condition may be defined after performing the adjustment under a plurality of conditions.

The saturation state of the detection signals of optical sensors 16, 17 is checked by calculation unit PC (step S15). The saturation state of the detection signal is distinguished by categorization into pattern A in which both are saturated, pattern B in which only optical sensor 16 is saturated, pattern C in which only optical sensor 17 is saturated, and pattern D in which both are not saturated.

Accurate measurement cannot be performed for pattern A, because both optical sensors 16, 17 are saturated. Thus, gain adjustment is needed, and an adjustment flow will be described with reference to FIG. 4C and FIG. 4D.

In the first adjustment, the sensitivity of optical sensor 16 is lowered by reducing the gain of optical sensor 16 by calculation unit PC (step S16-1), and then the step returns to step S1 (FIG. 4C).

When both optical sensors 16, 17 are saturated even after the first adjustment, the second adjustment is performed to reduce the gain of optical sensor 17 by calculation unit PC to lower the sensitivity of optical sensor 17 (step S16-2), and then the step returns to step S1 (FIG. 4D).

When both optical sensors 16, 17 are saturated even after the second adjustment, calculation unit PC repeatedly performs step S16-1 in the odd-numbered adjustment and step S16-2 in the even-numbered adjustment to create a state in which at least one of optical sensor 16 and optical sensor 17 is not saturated, and after completion of the adjustment, calculation unit PC turns on the gain adjustment completion flag and records the set gain (step S17).

In pattern B, at least one of optical sensors 16, 17 is not saturated and thus accurate measurement can be performed, so that calculation unit PC turns on the gain adjustment completion flag and records the set gain (step S17) (FIG. 4B).

In pattern C, at least one of optical sensors 16, 17 is not saturated and thus accurate measurement can be performed, so that calculation unit PC turns on the gain adjustment completion flag and records the set gain (step S17).

In pattern D, neither of optical sensors 16, 17 is saturated and thus accurate measurement can be performed, so that calculation unit PC turns on the gain adjustment completion flag and records the set gain (step S17) (FIG. 4A).

After completion of the adjustment, calculation unit PC confirms that the gain adjustment flag is on, and switches to main measurement. Measurement is repeated for a predetermined number of times until the main measurement is completed (step S18), and the measurement ends.

According to the first exemplary embodiment, when the detection signals of the emitted lights at optical sensors 16, 17 are saturated, the gain of the optical sensor is adjusted and set by calculation unit PC (as an example controller) to make the detection signal of the emitted light at at least one of optical sensors 16, 17 not saturated, and thus the detection signal of the emitted light at at least one of optical sensors 16, 17 is not saturated and can be accurately measured. Further, by setting the dynamic ranges of optical sensors 16, 17 to be continuous, optical sensors 16, 17 can be used like a single sensor having a continuous measurement range. Such a laser processing monitoring device has a wider dynamic range than a laser processing monitoring device including a single optical sensor. Therefore, the laser processing monitoring device of the first exemplary embodiment can monitor laser processing in a wide dynamic range with no change in the configuration of the optical system.

### Second exemplary embodiment

In the second exemplary embodiment, a case where measurement light is branched into three or more to be measured will be described.

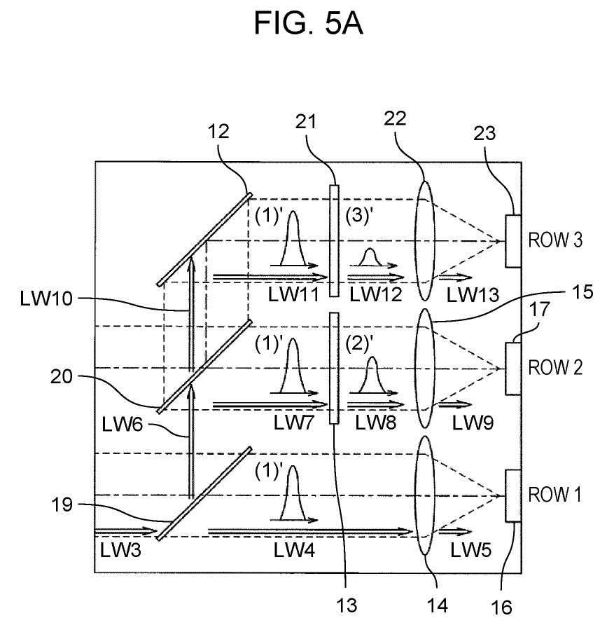

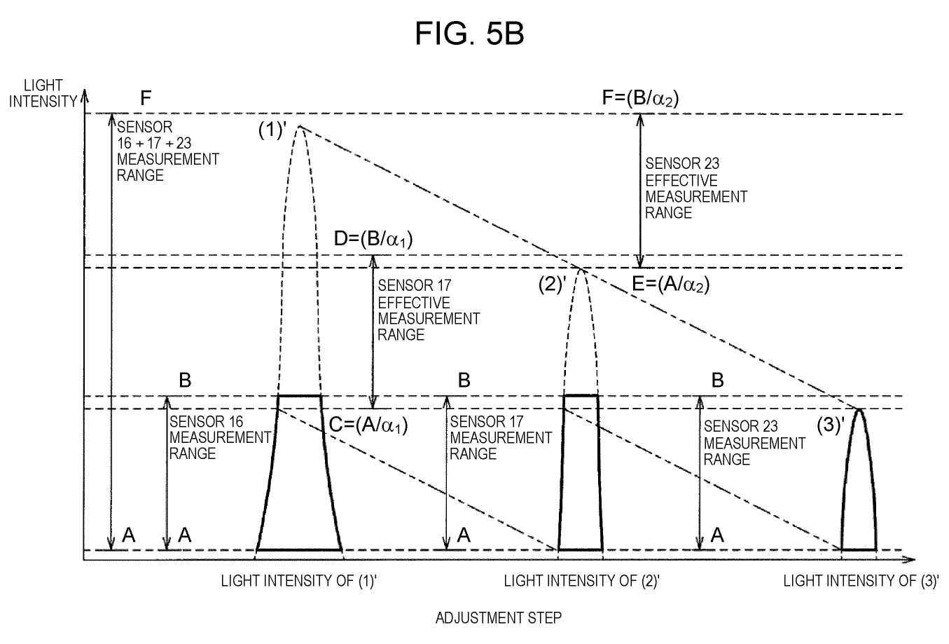

FIG. 5A is a schematic diagram of a measurement unit of a laser processing monitoring device where measurement light is branched into three. In FIG. 5A, only a portion corresponding to measurement unit 18 in FIG. 1 is illustrated, and the same components are denoted by the same reference marks, and description thereof is omitted. From the lower side in the drawing, optical systems having optical sensors are referred to as row 1, row 2, and row 3. In FIG. 5B, the transmittance of light attenuating elements 13, 21 will be described using a chart in which the horizontal axis is adjustment step and the vertical axis is light intensity (W).

Welding light LW3 that has entered measurement unit 18 is incident on partial reflection mirror 19.

As an example, in the second exemplary embodiment, partial reflection mirror 19 is configured with a beam splitter, and transmits light amount of about 33%, which is one third, of welding light LW1 generated from molten region M and reflects the rest of about 67% of the light. Welding light LW4 that has passed through partial reflection mirror 19 is condensed by condensing lens 14 and received by optical sensor 16.

Optical sensor 23, like optical sensors 16, 17, detects the intensity of the received light and converts the intensity into an electrical signal such as a voltage value or a current value. Optical sensor 23 includes a photodiode, an A/D converter, and the like, and is communicably connected to calculation unit PC. The detection signal is input to calculation unit PC. Since light is attenuated by light attenuating element 13 and light attenuating element 21, when the gain settings of optical sensors 16, 17 are the same, the measurement range of optical sensor 17 is larger than that of optical sensor 16, and the measurement range of optical sensor 23 is larger than that of optical sensor 17. Calculation unit PC serves as a gain controller for optical sensors 16, 17, 23.

In the second exemplary embodiment, the measurement ranges of light intensities that can be measured by optical sensors 16, 17, 23 are the same and provided that the measurement range is from A W to B W, an ND filter having a transmittance α₁ (A/B < α₁ < 1.0) is used as light attenuating element 13, and an ND filter having a transmittance α₂ (A²/B² < α₂ < 1.0) is used as light attenuating element 21. Note that the reflectance of partial reflection mirror 20 may be adjusted and used instead of light attenuating element 13, or a beam splitter having a desired reflectance may be used instead of light attenuating element 21 and reflection mirror 12.

Welding light LW6 reflected by partial reflection mirror 19 is incident on partial reflection mirror 20.

As an example, in the first exemplary embodiment, partial reflection mirror 20 is configured with a half mirror, and reflects light of about 50% of the light reflected by partial reflection mirror 19 and transmits the rest of about 50% of the light.

Welding light LW7 reflected by partial reflection mirror 20 has a light amount of about 33%, which is about one third, of the light generated from molten region M. Welding light LW7 passes through light attenuating element 13. Light attenuating element 13 includes, for example, an ND filter. The transmittance of light attenuating element 13 is set such that the measurement ranges of optical sensor 16 and optical sensor 17 are continuous. The transmittance of light attenuating element 13 is α₁ (< 1.0). The measurement ranges of optical sensors 16, 17 are from A W to B W. The light intensities of welding light LW4 and welding light LW7 are the same, and are indicated by (1)’ in the diagram. For light intensity of (1)’, the low intensity portion is measured by optical sensor 16, and the middle intensity portion is measured by optical sensor 17.

As the light is attenuated by light attenuating element 13, optical sensor 17 measures attenuated welding light LW8, that is, the light intensity of (2)’ in the diagram. At this time, when the effective measurement range of the light intensity at optical sensor 17 for the light intensity of (1)’ is defined to range from C W to D W, C = A/α₁ and D = B/α₁ are given from the transmittance α₁ and the measurement range from A W to B W of optical sensor 17. To make the measurement ranges of optical sensor 16 and optical sensor 17 continuous, lower limit C = A/α₁ of the measurement range of the light intensity at optical sensor 17 needs to be smaller than upper limit B of the measurement range of the light intensity at optical sensor 16, so that setting the transmittance α₁ of light attenuating element 13 to satisfy α₁ > A/B makes the measurement range of optical sensor 17 continuous with the measurement range of optical sensor 16. The light that has passed through light attenuating element 13 is condensed by condensing lens 15 and received by optical sensor 17.

Welding light LW10 that has passed through partial reflection mirror 20 is incident on reflection mirror 12.

Welding light LW11 reflected by reflection mirror 12 has a light amount of about 33%, which is about one third, of the light generated from molten region M. Welding light LW11 passes through light attenuating element 21. Light attenuating element 21 includes, for example, an ND filter. The transmittance of light attenuating element 21 is set such that the measurement ranges of optical sensor 17 and optical sensor 23 are continuous. The transmittance of light attenuating element 21 is defined as α₂ (< 1.0). The measurement ranges of optical sensors 17, 23 are defined to range from A W to B W. The light intensities of welding light LW7 and welding light LW11 are the same, and are indicated by (1)’ in the diagram. For the light intensity of (1)’, the middle intensity portion is measured by optical sensor 17, and the high intensity portion is measured by optical sensor 23. As the light is attenuated by light attenuating element 21, optical sensor 23 measures attenuated welding light LW12, that is, the light intensity of (3)’ in the diagram. At this time, when the effective measurement range of the light intensity at optical sensor 23 for the light intensity of (1)’ is defined to range from E W to F W, E = A/α₂ and F = B/α₂ are given from the transmittance α₂ and the measurement range from A W to B W of optical sensor 23. To make the measurement ranges of optical sensor 17 and optical sensor 23 continuous, lower limit E = A/α₂ of the measurement range of the light intensity at optical sensor 23 needs to be smaller than upper limit D = B/α₁ of the measurement range of the light intensity at optical sensor 17, so that setting the transmittance α₂ of light attenuating element 21 to satisfy α₂ > Aα₁/B > A²/B² makes the measurement range of optical sensor 23 continuous with the measurement range of optical sensor 17.

The light that has passed through light attenuating element 21 is condensed by condensing lens 22 and received by optical sensor 23.

The measurement regions of optical sensors 16, 17, 23 are preferably set to include molten region M of workpiece W. When changing the measurement region, for example, a method of adjusting the focal lengths of condensing lenses 14, 15, 22 may be used. For example, when lenses having a focal length of 100 mm are used as condensing lenses 14, 15, 22 instead of lenses having a focal length of 200 mm, a region that is twice the light receiving size of optical sensors 16, 17, 23 can be measured. It is preferable to adjust the focal length according to the measurement region selected by such a way. As another example, a method of limiting the measurement region by providing an aperture whose opening diameter is changeable at a place immediately before optical sensors 16, 17, 23 can also be used.

When the measurement light is branched into n (n is an integer of 3 or more), row 1 includes a partial reflection mirror, a condensing lens, and an optical sensor, row 2 to row (n-1) include a partial reflection mirror, a light attenuating element, a condensing lens, and an optical sensor, and row n includes a reflection mirror, a light attenuating element, a condensing lens, and an optical sensor. The amount of the welding light that has advanced via the partial reflection mirror and the reflection mirror is 100/n%, which is about one n-th of the light generated from molten region M. A transmittance αₘ of the light attenuating element in the m-th row among row n is expressed by (A^{m}⁻¹/B^{m}⁻¹ < αₘ₋₁ < 1.0).

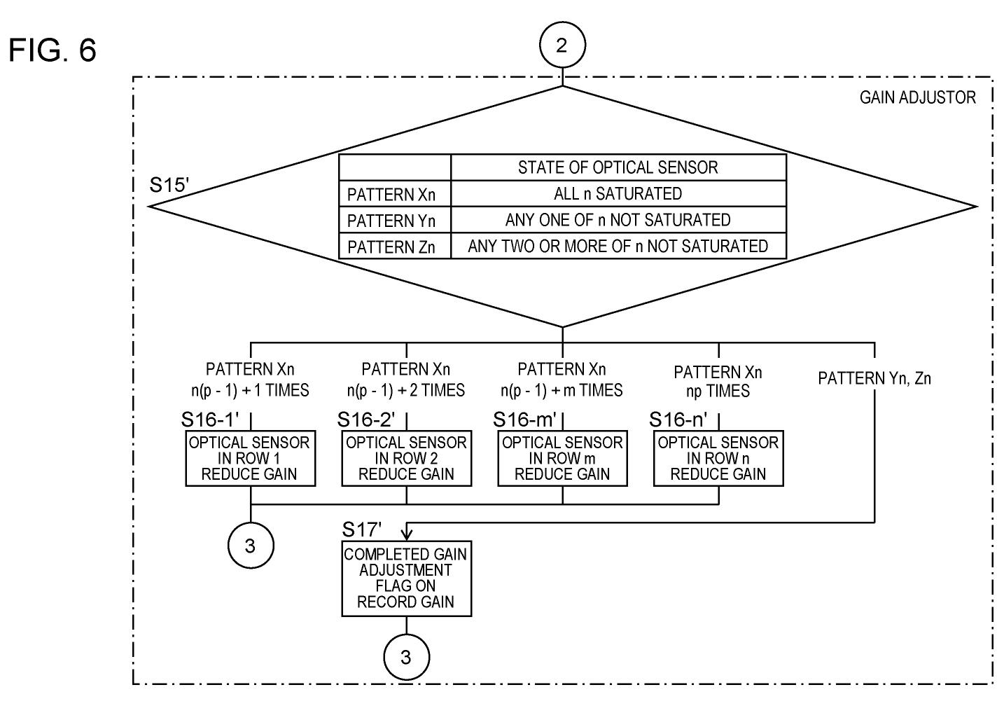

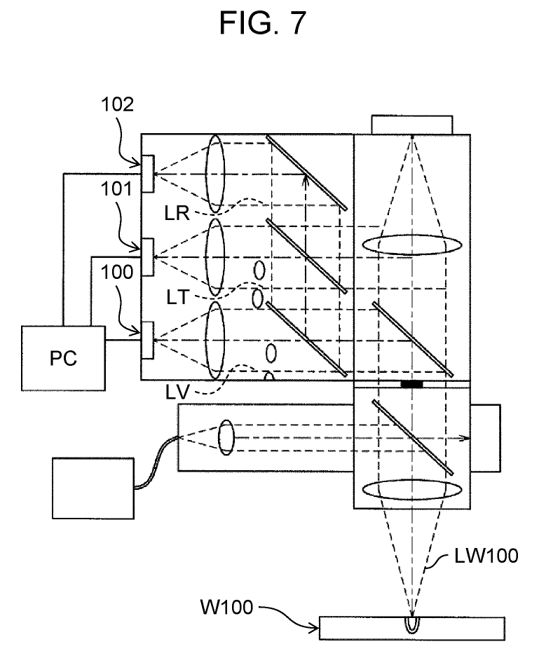

Next, a light detection method of the second exemplary embodiment of the present disclosure will be described. The peak of the light intensity is measured. FIG. 6 is a measurement flowchart of a case where the number of optical sensors according to the second exemplary embodiment of the present disclosure is n. Components except a gain adjustor are similar to those of the first exemplary embodiment, and thus the overlapping description will be omitted.

When the optical sensors in row 1 to row n detect the welding lights, it is necessary that gains have been set and signal intensities have been adjusted by calculation unit PC, but there is a case where an initial value has been set at the time of measurement but is not in valid setting. Calculation unit PC checks the gain adjustment completion flag, and when the gain adjustment is not completed, gain adjustment is performed and then the step proceeds to gain recording (step S14).

For the gain adjustment by calculation unit PC, the adjustment is performed under a laser beam condition where the signal intensity is assumed to be the highest among laser beam conditions that may be used. A suitable condition is generally a condition with the maximum laser power or the maximum energy density, but if it is difficult to uniquely determine the condition, the condition may be defined after performing the adjustment under a plurality of conditions.

The saturation state of the detection signals of optical sensors in row 1 to row n is checked by calculation unit PC (step S15’). The saturation state of the detection signal is categorized into pattern Xn in which all the n optical sensors are saturated, pattern Yn in which any one of the n optical sensors is not saturated, and pattern H in which two or more of the n optical sensors are not saturated.

Accurate measurement cannot be performed for pattern Xn, because all the n optical sensors are saturated. Therefore, the following gain adjustment is required.

In the first adjustment, the sensitivity of the optical sensor in row 1 is lowered by reducing the gain of the optical sensor in row 1 by calculation unit PC (step S16-1’), and then the step returns to step S1.

When all the n optical sensors are saturated even after the second adjustment, the second adjustment is performed to reduce the gain of the optical sensor in row 2 by calculation unit PC to lower the sensitivity of the optical sensor in row 2 (step S16-2’), and then the step returns to step S1.

Similarly, when all the n optical sensors are saturated even after the m-th adjustment until the n-th adjustment (m is a natural number, where m ≤ n), the m-th adjustment is performed to reduce the gain of the optical sensor in row m by calculation unit PC to lower the sensitivity of the optical sensor in row m (step S16-m’), and then the step returns to step S1.

When all the optical sensors are saturated even after the n-th adjustment, calculation unit PC repeatedly performs the steps that are step S16-1’ in the (n+1)-th adjustment, step S16-2’ in the (n+2)-th adjustment, and similarly, step S16-m’ in the (n+m)-th adjustment to create a state of pattern Yn in which at least one of the n optical sensors is not saturated, and after completion of the adjustment, the gain adjustment completion flag is turned on and the set gain is recorded (step S17’).

In pattern Yn, at least one of the n optical sensors is not saturated and thus accurate measurement can be performed, so that calculation unit PC turns on the gain adjustment completion flag and records the set gain (step S17).

In pattern Zn, at least one of the n optical sensors is not saturated and thus accurate measurement can be performed, so that calculation unit PC turns on the gain adjustment completion flag and records the set gain (step S17).

According to the second exemplary embodiment, when the detection signals of the emitted lights at all the three or more n optical sensors are saturated, the gain of at least one of optical sensors is adjusted and set by calculation unit PC (as an example controller) so that the detection signal of the emitted light at the optical sensor is not saturated, and thus the detection signal of the emitted light at at least one of all optical sensors is not saturated and can be accurately measured. In addition, by setting the dynamic range of all the optical sensors to be continuous, all the three or more optical sensors can be used as a single sensor having a continuous measurement region, and measurement can be performed using a wider dynamic range than using one sensor.

### Other exemplary embodiments

In each of the first exemplary embodiment and the second exemplary embodiment, there is an optical path with no light attenuating element disposed thereon, but the present disclosure is not limited to such a configuration. A light attenuating element may be disposed on every optical path to configure an optical system including optical paths having different light amount transmittances to the respective optical sensors.

By combining any of the various exemplary embodiments and modifications described above as appropriate, the effect of the exemplary embodiments or modifications can be obtained. Combinations of exemplary embodiments, combinations of examples, and combinations of exemplary embodiments and examples can be made, and combinations of features in different exemplary embodiments and examples can also be made.

### Supplementary note

The above description of the exemplary embodiments discloses the following techniques.

### Technique 1

There are included at least two optical sensors that detect emitted light generated from a workpiece subjected to laser processing, and

a light attenuating element disposed on at least one optical path among at least two optical paths branched off from the emitted light to be transmitted to the at least two optical sensors, wherein

the light attenuating element has a transmittance to cause measurement ranges of the at least two optical sensors to be continuous.

### Technique 2

The laser processing monitoring device according to Technique 1, wherein at least one optical sensor among the at least two optical sensors has a gain that is set to avoid saturation of a detection signal of the emitted light at the optical sensor.

### Technique 3

The laser processing monitoring device according to Technique 1 or 2, wherein the emitted light has wavelengths including a wavelength of a processing laser, a visible wavelength that ranges from 400 nm to 700 nm, and an infrared wavelength that ranges from 700 nm to 7000 nm.

### Technique 4

The laser processing monitoring device according to any one of Techniques 1 to 3, wherein the light attenuating element is at least one of an ND filter, a half mirror, and a dichroic mirror.

### Technique 5

The laser processing monitoring device according to any one of Techniques 1 to 4, wherein a number of optical paths is n, and at least two optical paths in which the light amount transmittances decrease by 100/n% are included.

According to these configurations, when the detection signals of the emitted lights at all the optical sensors are saturated, the gain of at least one of the optical sensors is adjusted and set so that the detection signal of the emitted light at the optical sensor is not saturated, and thus the detection signal of the emitted light at at least one of all the optical sensors is not saturated and can be accurately measured. Further, by setting the dynamic ranges of a plurality of optical sensors to be continuous, at least two optical sensors can be used like a single sensor having a continuous measurement range. Such a laser processing monitoring device has a wider dynamic range than a laser processing monitoring device including a single optical sensor. Therefore, such a laser processing monitoring device can monitor laser processing in a wide dynamic range with no change in the configuration of the optical system.

As a result, for example, when a laser output or a member is changed, the dynamic range is widened by a change in an optical path and/or automatic gain adjustment according to the light emission intensity at a processing point, so that saturation of the output signal of an optical sensor can be prevented with no need of change in the configuration of the optical system, and the state at the processing point can be accurately detected.

### INDUSTRIAL APPLICABILITY

A laser processing monitoring device according to the aspect of the present disclosure is industrially useful in that the state of laser processing can be monitored in a wide dynamic range by automatic adjustment with no change in the configuration of an optical system.

### REFERENCE MARKS IN THE DRAWINGS

1: laser oscillator

2: optical fiber

3: lens barrel

4: collimating lens

5: condensing lens

6, 7: partial reflection mirror

8: laser output sensor

9: condensing lens

10: imaging camera

11, 19, 20: partial reflection mirror

12: reflection mirror

13, 21: light attenuating element

14, 15, 22: condensing lens

16, 17, 23: optical sensor

18: measurement unit

LB, LB1, LB2, LB3, LB4, LB5, LB6: light beam

LW, LW1, LW2, LW3, LW4, LW5, LW6, LW7, LW8, LW9, LW10, LW11, LW12, LW13: welding light

M: molten region

PC: calculation unit

W: workpiece

100, 101, 102: optical sensor

W100: workpiece

LW100: welding light

1. A laser processing monitoring device comprising:
at least two optical sensors that detect emitted light generated from a workpiece subjected to laser processing; and
a light attenuating element disposed on at least one optical path among at least two optical paths branched off from the emitted light to be transmitted to the at least two optical sensors,
wherein the light attenuating element has a transmittance to cause measurement ranges of the at least two optical sensors to be continuous.

2. The laser processing monitoring device according to claim 1, wherein at least one optical sensor among the at least two optical sensors has a gain that is set to avoid saturation of a detection signal of the emitted light at the at least one optical sensor.

3. The laser processing monitoring device according to claim 1, wherein the emitted light has wavelengths including a wavelength of a processing laser, a visible wavelength that ranges from 400 nm to 700 nm, and an infrared wavelength that ranges from 700 nm to 7000 nm.

4. The laser processing monitoring device according to claim 1, wherein the light attenuating element is at least one of a Neutral Density (ND) filter, a half mirror, and a dichroic mirror.

5. The laser processing monitoring device according to claim 1, wherein a number of optical paths is n, and a second one of the light attenuating elements has a transmittance that is set smaller by 100/n% than a transmittance of a first one of the light attenuating elements.
